(19) United States
(12) Patent Application Publication
(10) Pub. No.: US 2004/0224699 A1
(43) Pub. Date: Nov. 11, 2004

(54) Targeted information access via portable device

(75) Inventor: Stephen M. Bull, New York, NY (US)

Correspondence Address: BEVER HOFFMAN & HARMS, LLP, TRI-VALLEY OFFICE, 1432 CONCANNON BLVD., BLDG. G, LIVERMORE, CA, 94550, US

(73) Assignee: Cutlass, Inc.

(21) Appl. No.: 10/435,283

(22) Filed: May 8, 2003

(51) Int. Cl. H04Q 7/20

(52) U.S. Cl. 455/456.1; 455/435.1

(57) ABSTRACT

A portable device provides a user with access to personalized information about the region in which the device is located. The device sends an identification signal to a communications system. The identification signal can include location information for the device, or the communications system itself can determine the location of the device. Using the device location, the communications system gathers localized information, which is filtered by a set of predefined data selection preferences for the user that are associated with identification information included in the identification signal. The communications system sends the resulting personalized local information to the portable device for access by the user.

### BACKGROUND OF THE INVENTION

1. Field of the Invention

The invention relates to information access and distribution systems, and more particularly to a system and method for providing a user with personalized information associated with the location of the user.

2. Related Art

In the modern world, travel has become a common activity for most people. Oftentimes, such travel can take an individual to places that he or she is not familiar with. In those circumstances, it is extremely helpful for that individual to have access to localized information—i.e., information about the place in which he or she is situated. Every location (e.g., site, city, landmark, region, etc.) has an associated “meta-layer” of localized information, but effectively accessing this meta-layer can be problematic.

The main problem is that because of the sheer quantity of information associated with any given location, it can be extremely difficult to extract just the information that an individual in that location would find useful and/or interesting. For example, a business traveler may need to find the nearest copy and fax center. On the other hand, a tourist may want to know about the history and visiting hours of a local attraction. Different people will have different preferences and needs, and so conventional “one size fits all” data sources can be inadequate.

FIG. 1 depicts several conventional means for accessing localized information. FIG. 1 shows a user 100 in the vicinity of a local attraction 110, such as a museum, historical landmark, or other site of interest. To obtain information about local attraction 110, user 100 might be able to read a posted placard 120 directly from local attraction 110. Alternatively, user 100 could read about local attraction 110 from a tourbook 130, or even listen to the information from a preprogrammed tour system 140. However, these types of data sources will typically not be optimal means for user 100 to access information about local attraction 110.

For example, tourbooks, maps, and other printed materials are popular sources of localized information, but come with significant limitations. Publications of this sort can be considered “static” sources, because the information in those sources is fixed; i.e., each time a static source is accessed, the information will be the same. Therefore, a static source will often provide outdated information. For instance, tourbook 130 might list incorrect hours of operation for local attraction 110.

Furthermore, since the content of the static source must be defined prior to publication, the content creator (author, publisher, etc.) will not know what particular information the users of the source will want or need. As a result, a static source will almost always have too little or too much information for a particular user. For example, tourbook 130 might not even mention local attraction 110. Alternatively, tourbook 130 might bury the information about local attraction 110 in a lengthy listing of other local attractions, making the information difficult to find. In either case, user 100 is denied efficient access to the desired information.

Posted placards, kiosks, signposts, and other “attached” data sources are less susceptible to these problems of data currency and relevancy, since the only function of an attached data source is to provide information about the attraction to which it is attached. However, an attached data source is basically inaccessible to an individual who does not have immediate physical access to (or does not recognize) the associated local attraction. For example, user 100 could be a few streets away from local attraction 110, in which case placard 120 would not be of any use unless user 100 had prior knowledge of the existence and location of local attraction 110. Also, placard 120 could be in a language that user 100 does not understand, particularly if user 100 is in a foreign country.

Similarly, preprogrammed tour systems provide localized information for individuals that are at a particular local attraction. Such tour systems, which are often used in museums and galleries to allow patrons to conduct self-guided tours, are designed to provide detailed information about specific items (e.g., artworks, artifacts, and other items of interest), and are often controlled by proximity sensors in the vicinity of those specific items. However, once again, the content of such tour systems is predefined by the tour operator and therefore will not be targeted to the actual user. For example, tour system 140 might be programmed to tell user 100 about the history of local attraction 110, while user 100 might be interested in the construction details of the building. Furthermore, like attached data sources, preprogrammed tour systems require that the user have knowledge about both the availability and the location of the tour system itself.

Thus, conventional sources for localized information are all hampered by the fact that the information they provide is not targeted to the recipient of that information. With the growth of the Internet, various online resources have been developed to provide localized information. However, even those online data sources are simply electronic versions of the traditional printed tourbooks and maps, and are still limited by the fact that the content provided to a user is selected by the creator of the online resource, and is therefore not targeted to the user.

For example, a popular internet-based localized data access tool is VINDIGO™ (available at http://www.vindigo.com). A VINDIGO™ user downloads an application that runs on a personal digital assistant (PDA) or web-enabled cellular telephone. Localized information (e.g., restaurant reviews, movie listings, museum hours, etc.) that has been programmed into the application can then be accessed by the user via the PDA or cellular telephone. However, just as with other types of localized data sources, the VINDIGO™ user remains at the mercy of the content provider, who simply provides a predetermined mass of data in the downloadable application. While the PDA or cellular phone interface can simplify the filtering of that data by the user, the fact remains that the data provided in the VINDIGO™ application is not targeted to the user, and is therefore likely to be either excessive or inadequate for that user.

Accordingly, it is desirable to provide a method and system for providing and obtaining efficient access to targeted localized information.

### SUMMARY OF THE INVENTION

By using both predefined data selection preferences and location information, personalized local information (“targeted information”) can be provided to a user via a portable device. This targeted information eliminates the need for the user to sift through extraneous information to get to the information of interest.

According to an embodiment of the invention, a system for providing targeted information to a user includes a communications system for receiving an identification signal from a portable device. The identification signal includes identification information about the user or device, and the communications system uses that identification information to extract the targeted information from a data source.

According to an embodiment of the invention, the portable device can generate an identification signal that also includes location information, the location information being either generated by the device (e.g., via GPS technology) or entered by the user. Alternatively, the communications system itself can determine the location of the portable device (e.g., based on the signal strength, or via triangulation, of a cellular telephone signal).

According to another embodiment of the invention, the identification signal can also include data selection preferences associated with the user, the data selection preferences having been previously entered into the portable device by the user. Alternatively, the data selection preferences can be stored according to user identification information in either the communications system or in the data source. Data selection preferences from the portable device can even be combined with data selection preferences stored in the communications system or data source.

The communications system gathers the targeted information from the data source by using the location information to restrict the data to only that relating to the locality of the user, and by using the predefined data selection preferences to further limit the data to only that which is of interest to the user. In this manner, personalized local information access is provided to a user in a convenient and efficient manner.

According to various embodiments of the invention, the data source can comprise any type of information repository, from a data warehouse local to the communications system to a multitude of servers connected to the Internet. For internet-based systems, web-based forms can be used to streamline and organize data entry.

The invention will be more fully understood in view of the following description and drawings.

### BRIEF DESCRIPTION OF THE DRAWINGS

FIG. 1 is a diagram of various conventional means for obtaining localized information.

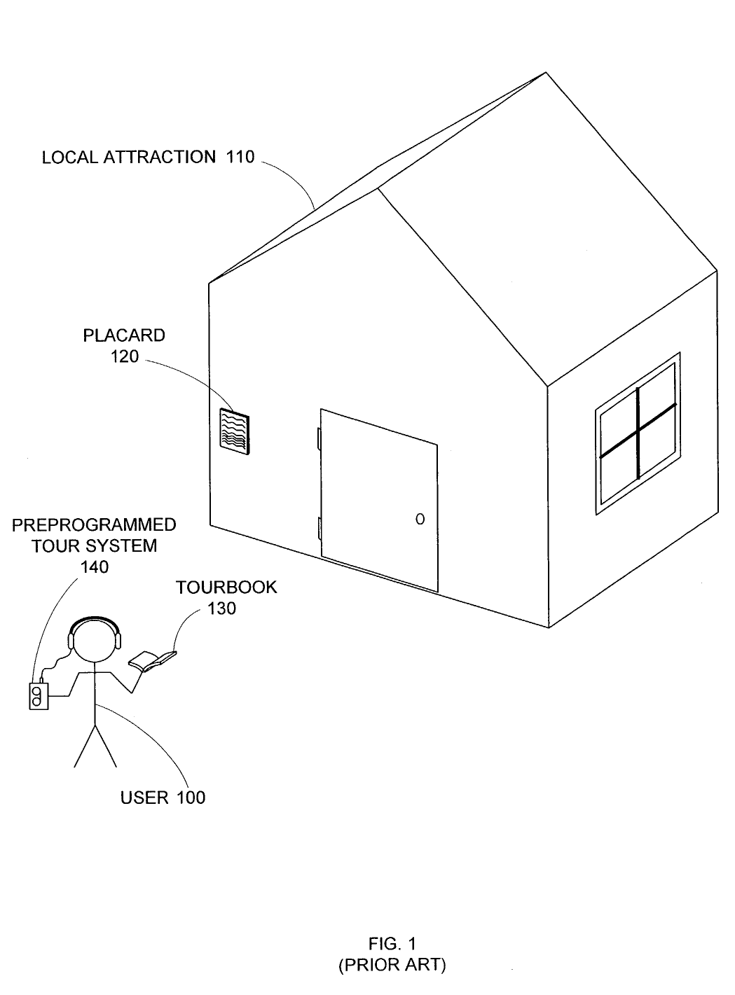

FIG. 2A is a diagram of a system for accessing targeted local information via a portable device, in accordance with an embodiment of the invention.

FIG. 2B is a screenshot of a data entry interface for entering local information into a data storage location, according to an embodiment of the invention.

FIG. 3 is a flow diagram for a method of providing targeted data to a portable device, according to an embodiment of the invention.

FIG. 4 is a flow diagram for a method of operating a portable device to access targeted data, according to an embodiment of the invention.

### DETAILED DESCRIPTION

The invention uses positional data and user-defined preferences to beneficially provide a user with personalized local information.

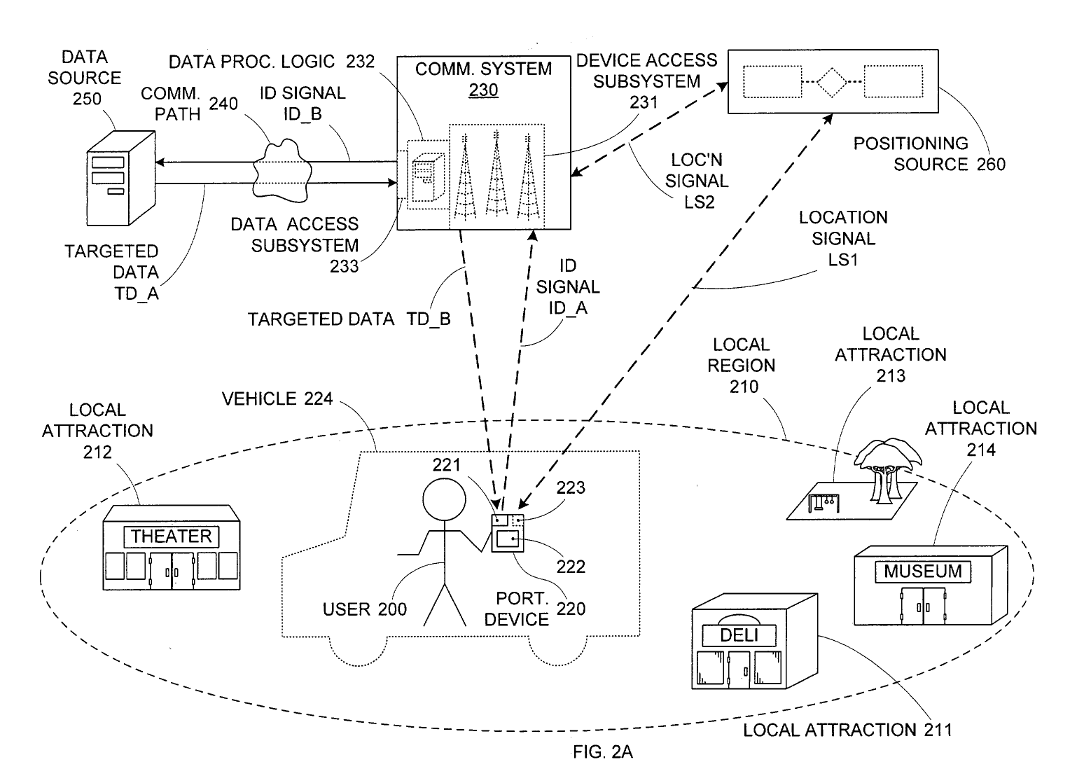

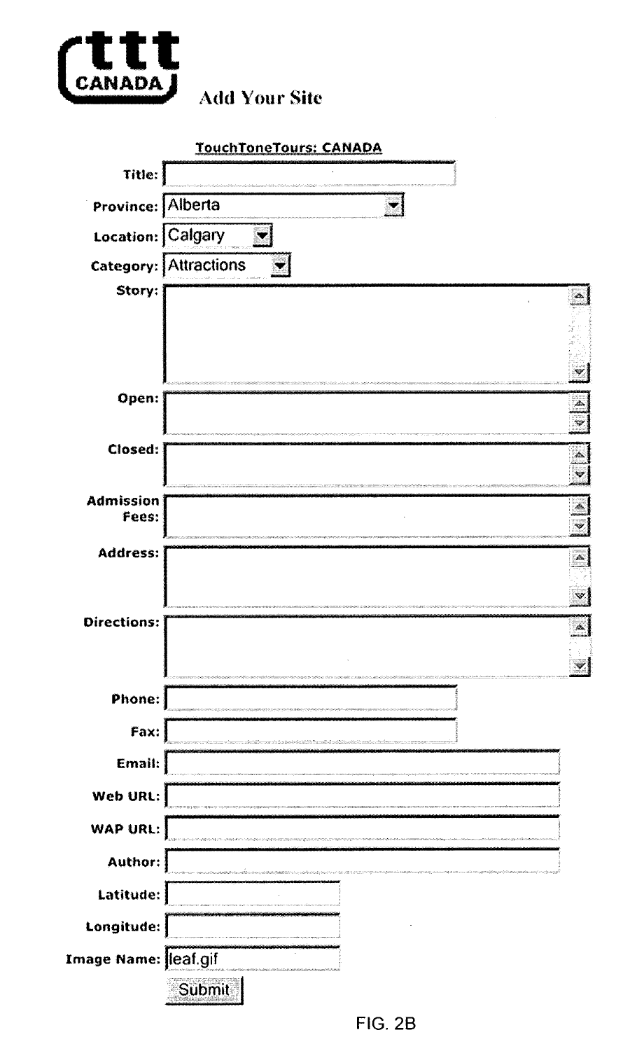

FIG. 2A is a graphical representation of a personalized local information access system, according to an embodiment of the invention. A user 200 with a portable device 220 is situated in a local region 210. Portable device 220 transmits an identification signal ID_A to a communications system 230. Communications system 230 then sends an identification signal ID_B to a data source 250 via a communications path 240. Using identification and location data included in identification signal ID_B, data source 250 compiles targeted data TD_A that is based on the location of portable device 220 and also on a set of data selection preferences previously defined by user 200. Targeted data TD_A is then conveyed back to portable device 220 by communications system 230 as targeted data TD_B. In this manner, user 200 is granted easy access to information about local region 210 that is based on his or her personal preferences.

Prior to the transmission of identification signal ID_A by portable device 220, user 200 defines the set of data selection preferences that will be used to filter the local data that is ultimately received by portable device 220. This set of data selection preferences may be stored remotely (e.g., in data source 250 or in communications system 230) or locally (in portable device 220).

Note that the set of data selection preferences can be defined at any point in time before portable device 220 transmits identification signal ID_A. For example, according to an embodiment of the invention, user 200 could enter his set of data selection preferences into data source 250 via the Internet from his home computer. This “preference entry” could, for example, be performed far in advance of user 200's entry into local region 210. According to another embodiment of the invention, user 200 could enter his set of data selection preferences into portable device 220 after entering local region 210, just before the transmission of identification signal ID_A by portable device 220.

Note also that the data selection preferences can comprise any information provided by user 200 that can be used to filter the local data. For example, according to various embodiments of the invention, the predefined data selection preferences can include categorical specifications (e.g., art, history, pop culture, or youth-oriented), activity selections (e.g., museums, theaters, or restaurants), or even user-specific plans (e.g., travel itineraries or business agendas).

For example, assume local region 210 includes local attractions 211, 212, 213, and 214, which can represent a deli, a theater, a park, and a museum, respectively. Assume further that the set of data selection preferences defined by user 200 only indicates an interest in the arts and live entertainment. Targeted data TD_B might then include information about showtimes and ticket availability for the current production at the theater (212) and the current exhibits at the museum (214), along with hours and admission fees. At the same time, information about the history of the park (213) or the house specialties of the deli (211) would not be included, thereby eliminating the need for user 200 to manually bypass this unwanted information. In this manner, the predefined set of data selection preferences ensures that only information that is of interest to user 200 is provided by portable device 220.

According to an embodiment of the invention, the data filtering process can also make use of environmental factors (e.g., weather or other environmental conditions). Then, for example, if rain makes an outdoor activity unfeasible or if a local attraction is closed for the winter, information about that activity or attraction is not supplied to portable device 220. This environmental factor filtering can therefore be used to further streamline the targeted data made available to user 200.

In any case, after the set of data selection preferences for user 200 is defined, the actual data access process begins with portable device 220 sending identification signal ID_A to a communication system 230. Portable device 220 can comprise any portable device that includes a communications component 221 for communicating with communications system 230, and a user interface component 222 that can output information to a user, such as a speaker, a textual display, or a graphical display. User interface component 222 can optionally also include input functionality to allow data input by user 200. Thus, according to various embodiments of the invention, portable device 220 can comprise a laptop computer, a personal digital assistant (PDA), a cellular telephone, or a personal pager. Portable device 220 can also optionally be mounted in a vehicle 224 (indicated by the dotted outline), which can be a car, bus, train, airplane, or any other transportation apparatus.

The communications between portable device 220 and communications system 230 can comprise any communications protocol. For example, an optional device access subsystem 231 in communications system 230 for communicating with portable device 220 could operate on cellular telephone technology (e.g., CDMA (Code Division Multiple Access), TDMA (Time Division Multiple Access), GSM (Global System for Mobile Communications), or GPRS (General Packet Radio Service), SMS (Short Messaging Service), or CDPD (Cellular Digital Packet Data)), wireless local area network (WLAN) technology (e.g., IEEE Stds. 802.11-1999, 802.11a-1999, 802.11b-1999, and 802.11g (expected ratification June 2003)), BLUETOOTH™ technology (e.g., Bluetooth SIG specification v1.1 2001), or HIPERLAN technology (e.g., ETSI Std. EN 300 652 V1.2.1 (1998-07)), among others.

According to an embodiment of the invention, portable device 220 can transmit identification signal ID_A in response to an action by user 200 (e.g., pressing a button or sequence of buttons, tapping an icon on a touch-screen display, or even speaking a command into user interface component 222). According to other embodiments of the invention, portable device 220 can automatically transmit identification signal ID_A, either constantly, or at predetermined intervals, or at scheduled times.

Identification signal ID_A includes ID information associated with portable device 220 and/or user 200. According to various embodiments of the invention, identification signal ID_A can also include positional information that specifies the location of device 220 and/or data selection preferences that have been defined by user 200. Table 1 lists examples of data types that can be included in identification signal ID_A.

TABLE 1
Examples of ID Signal ID_A

| | | Automated | Manual | Selection |
|---|---|---|---|---|
| Signal | ID | Position | Position | Preferences |
| ID_A(1) | X | | | |
| ID_A(2) | X | X | | |
| ID_A(3) | X | | X | |
| ID_A(4) | (X) | X | | X |
| ID_A(5) | (X) | | X | X |
| ID_A(6) | (X) | | | X |

For example, identification signal ID_A(1) in Table 1 is the most basic signal configuration, and only includes ID information from portable device 220. Note that this ID information can identify the device itself (e.g., devices that are generally used by a single person such as a cellular telephone or PDA) or it can be programmed to correspond to a particular user (e.g., a laptop computer in which the ID information corresponds to the particular user that is logged in to that computer).

In either case, since identification signal ID_A(1) only includes ID information, the positional information required to define local region 210 would have to be determined outside of device 220. According to an embodiment of the invention, communications system 230 could perform this “external” locating function. For example, portable device 220 could be a cellular telephone, in which case communications system 230 could comprise a system of receiving sites (such as cell towers (sometimes referred to as “cell sites”) or radio towers, as indicated by the dotted outlines). The location of portable device 220 (e.g., a cellular telephone or a radio transceiver) could then be associated with a region surrounding the particular receiving site at which the signal from portable device 220 is the strongest, or the receiving sites could triangulate the signal from portable device 220.

According to another embodiment of the invention, a dedicated positioning system such as optional positioning source 260 could be used to perform an external locating function. For example, portable device 220 could transmit optional location signal LS1 to optional positioning source 260 (e.g., a positioning satellite). Positioning source 260 would then determine the position of portable device 220 and relay that information to communications system 230 as an optional location signal LS2. In this situation, communications system 230 would be determining the location of portable device 220 by associating the ID information in identification signal ID_A with the corresponding location information from location signal LS2.

According to other embodiments of the invention, identification signal ID_A could include positional information about portable device 220. For example, identification signal ID_A(2) in Table 1 includes ID information and automated position information (i.e., position information automatically determined by portable device 220). The automated position information could, for instance, be determined by an optional positioning system module 223 in portable device 220. According to an embodiment of the invention, positioning module 223 can comprise a Global Positioning System (GPS) module that could receive location information from positioning source 260 (e.g., a GPS satellite) via location signal LS1. This automated location information would then be incorporated into identification signal ID_A.

Alternatively, identification signal ID_A(3) in Table 1 includes ID information and manual position information (i.e., location information entered by a user). User 200 could manually specify local region 210 by entering some positional reference into portable device 220 via user interface 222, and this positional reference would then be incorporated into ID signal ID_A. The positional reference can comprise anything that provides information about the location of portable device 220, such as a zip code, area code, city name, or even latitudinal and longitudinal coordinates.

According to other embodiments of the invention, ID signal ID_A can even include the set of data selection preferences defined by user 200. For example, portable device 220 could comprise a PDA or laptop computer into which user 200 has entered his set of data selection preferences. That set of data selection preferences could then be included in identification signal ID_A. As indicated in Table 1, identification signal ID_A could then include both automated position information and selection preferences (ID_A(4)), manual position information and selection preferences (ID_A(5)), or even selection preferences without any position information (ID_A(6)). Note that since the ID information is essentially an indicator for the particular set of data selection preferences to be used in the data filtering process, if identification signal ID_A already includes those data selection preferences, then the ID information need not be included in identification signal ID_A (as indicated by the parenthesized X's in the “ID” column for signals ID_A(4), ID_A(5), and ID_A(6)).

Once identification signal ID_A is received by communications system 230, communications system 230 can then compile the ID, location, and/or selection preference information into identification signal ID_B. Table 2 lists examples of different combinations of these information types that can be included in identification signal ID_B.

TABLE 2
Examples of ID Signal ID_B

| | | | Selection |
|---|---|---|---|
| Signal | ID | Location | Preferences |
| ID_B(1) | X | X | |
| ID_B(2) | (X) | X | X |

For example, identification signal ID_B(1) in Table 2 includes ID information and location information for portable device 220. As described above, the location information can either be generated by communications system 230 itself (e.g., via signal strength or triangulation methods), or by optional positioning source 260 (e.g., a positioning satellite), or could have been provided by identification signal ID_A. Regardless of the source, these various pieces of information can be compiled by optional data processing logic 232 in communications system 230, according to an embodiment of the invention. Note that identification signal ID_B provided by communications system 230 will always include location information, since such information cannot be stored ahead of time in data source 250, but rather must be determined each time portable device 220 is moved to a new location.

Identification signal ID_B can also include data selection preference information for user 200, as indicated by identification signal ID_B(2) in Table 2. According to an embodiment of the invention, the data selection preferences could simply be copied from identification signal ID_A into identification signal ID_B by data processing logic 232. According to another embodiment of the invention, communications system 230 could store predefined data selection preferences for user 200, and data processing logic 232 could incorporate those preferences into identification signal ID_B in response to the ID information provided by identification signal ID_A. According to another embodiment of the invention, data selection preferences from both communications system 230 and identification signal ID_A can be incorporated into identification signal ID_B.

Communications system 230 sends identification signal ID_B to data source 250 via communications path 240, which can comprise any type of communications link, such as a direct cable connection, a local area network (LAN), or a wide area network (WAN). Note that communications system 230 can optionally include a separate device access subsystem 233 for communicating with portable device 220, since the communications mode between communications system 230 and portable device 220 (e.g., wireless for convenience) will typically be different than the communications mode between communications system 230 and data source 250 (e.g., wired for speed). Data source 250 itself can comprise a variety of structures, ranging anywhere from a simple standalone data warehouse (e.g., an audio-video repository or a data server) in close physical proximity to communications system 230, to a large organization of sites on (or servers connected to) the Internet.

Note that the Internet, and in particular the World Wide Web (WWW), can provide a very efficient means for maintaining and developing data source 250. For example, FIG. 2B shows a screen capture of a data entry screen for data source 250, according to an embodiment of the invention. Such a form can provide a simple and straightforward way to enter information that is categorized both by “category” (to allow for preference filtering) and “location”. Furthermore, by making such a form available on the WWW, users at any location can contribute information to data source 250, thereby facilitating the expansion of the total amount of localized data available for access by users.

Returning to FIG. 2A, when identification signal ID_B is received by data source 250, data source 250 gathers data associated with local region 210 based on the location information included in identification signal ID_B. That “localized” data is filtered by the predefined set of data selection preferences associated with user 200, which could be provided in identification signal ID_B, could be stored somewhere in data source 250, or could be a combination of the two. For example, according to an embodiment of the invention, various sets of data selection preferences are housed at dedicated storage locations, and are catalogued according to user (or device) ID. Thus, the ID information in identification signal ID_B could be used to call up the set of data selection preferences associated with user 200 (or portable device 220).

The resulting “targeted” data (i.e., localized and personalized data) is sent back to communications system 230 by data source 250 as targeted data TD_A via communications path 240. Communications system 230 then relays the targeted data back to portable device 220 as targeted data TD_B, thereby providing user 200 with access to personalized information about local region 210.

According to an embodiment of the invention, communications system 230 can provide all of targeted data TD_A as targeted data TD_B. According to another embodiment of the invention, communications system 230 can selectively provide portions of targeted data TD_A as targeted data TD_B, depending on the characteristics of portable device 220. For example, if portable device 220 comprises a cellular telephone without a graphic display, data processing logic 232 might limit targeted data TD_B to only those portions of targeted data TD_A that include an audio component. By eliminating portions of targeted data TD_A that are incompatible with portable device 220, the communications bandwidth requirements between communications system 230 and portable device 220 can be minimized.

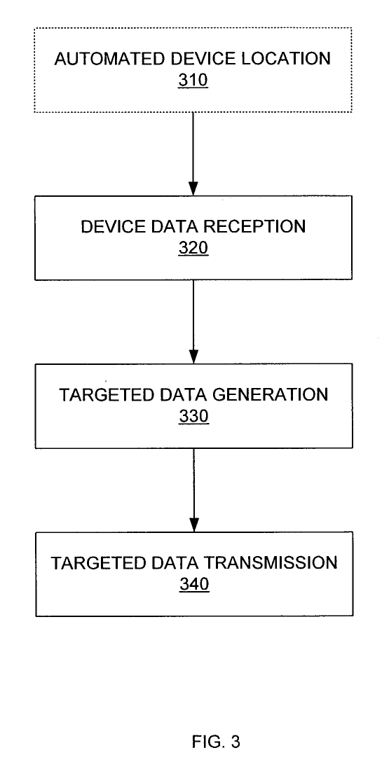

FIG. 3 shows a flow diagram for the operation of communications system 230 (shown in FIG. 2), according to an embodiment of the invention. In an optional “AUTOMATED DEVICE LOCATION” step 310 (indicated by the dotted outline), communication system 230 determines the location of portable device 220 (e.g., by cellular or radio triangulation, or by satellite positioning). Then, in a “DEVICE DATA RECEPTION” step 320, communications system 230 receives identification signal ID_A from portable device 220. As indicated in Table 1, identification signal ID_A can include a variety of combinations of ID, position, and data selection preference information.

Next, in a “TARGETED DATA GENERATION” step 330, communications system 230 collects the location information generated in step 310 or provided in identification signal ID_A (in step 320), and the data selection preferences provided in identification signal ID_A (in step 320) and/or stored in either communication system 230 or data source 250 (and accessed using ID information provided in identification signal ID_A). Communications system 230 uses this identification and location information to extract the targeted information for user 200 from data source 250. Then, in a “TARGETED DATA TRANSMISSION” step 340, the desired targeted information is transmitted by communications system 230 (to portable device 220).

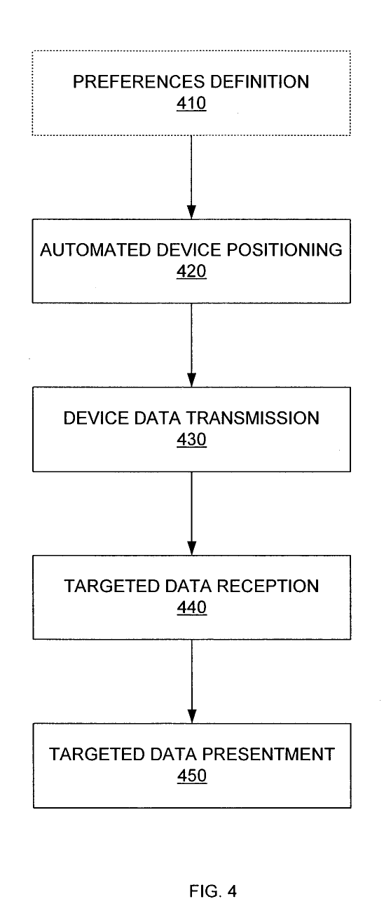

FIG. 4 shows a flow diagram for the operation of a portable device 220 (shown in FIG. 2), according to another embodiment of the invention. First, in an optional “PREFERENCES DEFINITION” step 410 (indicated by the dotted outline), a set of data selection preferences is specified by user 200. As described above, this set of data selection preferences can be stored in portable device 220 itself, in communications system 230, in data source 250, or in any combination of the three. Then, in an “AUTOMATED DEVICE POSITIONING” step 420, portable device 220 determines its location (e.g., using GPS capabilities).

Next, in a “DEVICE DATA TRANSMISSION” step 430, portable device 220 transmits identification signal ID_A. Since portable device 220 has determined its own location (in step 420), identification signal ID_A could comprise either configuration ID_A(2) or ID_A(4) shown in Table 1. In response to identification signal ID_A, portable device 220 receives the targeted data TD_B from communications system 230 in a “TARGETED DATA RECEPTION” step 440. Finally, portable device 220 provides user 200 with access to that localized, personalized data in a “TARGETED DATA PRESENTMENT” step 450. Note that the types of data presentment in step 450 can depend on the capabilities of portable device 220, and can include audio, video, pictorial, and textual modes, among others.

The various embodiments of the structures and methods of this invention that are described above are illustrative only of the principles of this invention and are not intended to limit the scope of the invention to the particular embodiments described. Thus, the invention is limited only by the following claims and their equivalents.

1. A method for providing information to a portable device, the method comprising:
receiving an identification signal from the portable device;
determining a location for the portable device using the identification signal;
accessing a predefined set of data selection preferences for a user of the portable device using the identification signal;
generating a target set of data associated with the location for the portable device and filtered according to the set of data selection preferences; and
sending the target set of data to the portable device.

2. The method of claim 1, wherein determining the location for the portable device comprises triangulating the identification signal from the portable device.

3. The method of claim 1, wherein receiving the identification signal from the portable device comprises receiving the identification signal by at least one of a set of receiving sites, and
wherein determining the location for the portable device comprises associating the portable device with a region surrounding the receiving site receiving the identification signal most strongly.

4. The method of claim 1, wherein determining the location for the portable device comprises associating identification information in the identification signal with location information provided by a positioning system.

5. The method of claim 1, wherein the identification signal includes the location of the portable device.

6. The method of claim 1, wherein accessing the predefined set of data selection preferences comprises providing identification information in the identification signal to a storage location, the storage location storing the predefined set of data selection preferences according to the identification information.

7. The method of claim 1, wherein the identification signal includes the predefined set of data selection preferences.

8. The method of claim 1, wherein generating the target set of data comprises:
sending the location for the portable device and identification information from the identification signal to a data source.

9. The method of claim 8, wherein the data source comprises a set of servers connected to the Internet.

10. The method of claim 9, wherein the identification information includes the predefined set of data selection preferences.

11. The method of claim 9, wherein the data source further comprises a storage location storing the predefined set of data selection preferences according to the identification information.

12. The method of claim 8, wherein generating the target set of data further comprises:
receiving an initial set of data from the data source in response to the location for the portable device and the identification information, the initial set of data containing all data from the data source associated with the location for the portable device and satisfying the predefined set of data selection preferences; and
creating the target set of data by eliminating portions of the initial set of data that are incompatible with the portable device.

13. The method of claim 1, wherein the target set of data is further filtered by environmental factors associated with the location for the portable device.

14. A system for providing information to a portable device, the system comprising:
a receiving system for receiving an identification signal from a portable device;
data processing logic for determining a location of the portable device from the identification signal;
a data access system for gathering an initial set of data from a data source, the initial set of data being associated with the location of the portable device and being filtered according to a predefined set of data selection preferences associated with identification information in the identification signal; and
a transmission system for transmitting a targeted set of information to the portable device, the targeted set of information comprising a portion of the initial set of data.

15. The system of claim 14, wherein the receiving system comprises a plurality of receiving sites, and wherein the data processing logic comprises logic for triangulating the identification signal.

16. The system of claim 14, wherein the receiving system comprises a plurality of receiving sites, and wherein the data processing logic comprises logic for assigning a region surrounding the receiving site receiving the identification signal most strongly as the location of the portable device.

17. The system of claim 16, wherein each of the plurality of receiving sites comprises a cell site.

18. The system of claim 14, wherein the data processing logic comprises logic for reading a location signal associated with the portable device from an external location system and associating the location signal with the identification information in the identification signal, the location signal providing the location of the portable device.

19. The system of claim 14, wherein the data processing logic comprises logic for reading the location of the portable device from the identification signal.

20. The system of claim 14, wherein the data source includes a storage area for housing the predefined set of data selection preferences according to the identification information.

21. The system of claim 20, wherein the data access system includes a communications subsystem for sending the location of the portable device and the identification information to the data source.

22. The system of claim 14, further comprising a storage area for housing the predefined set of data selection preferences according to the identification information.

23. The system of claim 22, wherein the data processing logic comprises logic for accessing the predefined set of data selection preferences from the storage area using the identification information, and
wherein the data access system includes a communications subsystem for sending the location of the portable device and the predefined set of data selection preferences to the data source.

24. The system of claim 14, wherein the data access system comprises a connection to the Internet.

25. The system of claim 14, wherein the system further comprises the data source.

26. The system of claim 14, wherein the targeted set of information comprises all of the initial set of data.

27. The system of claim 14, wherein the data processing logic comprises logic for eliminating data incompatible with the portable device from the initial set of data to form the targeted set of information.

28. A portable device comprising:
a positioning module for determining a location of the portable device;
a transmission module for sending identification information and the location of the portable device to a communications system;
a receiving module for receiving a set of information associated with the location of the portable device, the set of information being filtered by a set of data selection preferences associated with the identification information; and
a user interface module for outputting the set of information to a user.

29. The portable device of claim 28, wherein the portable device comprises one of a cellular telephone, a laptop computer, and a personal digital assistant.

30. The portable device of claim 28, wherein the portable device is mounted in a vehicle.

31. The portable device of claim 28, wherein the positioning module comprises a Global Positioning System module.

32. The portable device of claim 28, wherein the transmission module and the receiving module operate on one of cellular telephone technology, wireless local area network technology, and Bluetooth technology.

33. The portable device of claim 28, wherein the identification information comprises the set of data selection preferences, the user interface module including an input portion for entering the set of data selection preferences into the portable device.

34. The portable device of claim 28, wherein the transmission module includes transmission logic for sending the identification information and the location of the portable device to the communications system at predetermined intervals.

35. The portable device of claim 28, wherein the transmission module continuously sends the identification information and the location of the portable device to the communications system.

36. A method for accessing information via a portable device, the method comprising:
automatically determining a location of the portable device;
sending identification data and the location of the portable device to a data source; and
receiving a set of information from the data source, the set of information comprising data associated with the location of the portable device filtered by a set of data selection preferences associated with the identification data.
